(19) United States
(12) Patent Application Publication
(10) Pub. No.: US 2021/0243005 A1
(43) Pub. Date: Aug. 5, 2021

(54) FULLY HOMOMORPHIC ENCRYPTION METHOD AND DEVICE AND COMPUTER READABLE STORAGE MEDIUM

(71) Applicant: SHENZHEN UNIVERSITY, Shenzhen (CN)

(72) Inventors: Peng ZHANG, Shenzhen (CN); Xiaoqiang SUN, Shenzhen (CN)

(73) Assignee: SHENZHEN UNIVERSITY, Shenzhen (CN)

(21) Appl. No.: 17/255,671

(22) PCT Filed: Jul. 4, 2018
(86) PCT No.: PCT/CN2018/094430

§ 371 Date: Dec. 23, 2020

(51) Int. Cl. H04L 9/00; H04L 9/06; H04L 9/30

(52) U.S. Cl. CPC H04L 9/008; H04L 2209/12; H04L 9/3026; H04L 9/0618

(57) ABSTRACT

Provided are a fully homomorphic encryption method and device and a computer readable storage medium capable of enhancing efficiency of a homomorphic multiplication operation in a fully homomorphic encryption method. The method comprises: Step S1: generating a prime modulus qⱼ=qⱼ(λ, L), according to an input security parameter λ and a number of encryption layers L, wherein qⱼ mod n≡1, n is an integer power of 2, j=0, 1, . . . , L−1, and q₀<q₁< . . . <q_{L-1}; Step S2: generating a private key sk and a public key pk according to the prime modulus qⱼ; Step S3: encrypting plaintext m according to the public key pk; and Step S4: performing a homomorphic operation on two ciphertexts associated with the same private key, the homomorphic operation includes a homomorphic addition operation FHE.Add(c′, c″) and a homomorphic multiplication operation FHE.Mul(c′, c″).

### TECHNICAL FIELD

The present application relates to the field of computer encryption, and in particular, to a fully homomorphic encryption method, device, and computer-readable storage medium.

### BACKGROUND

Fully homomorphic encryption allows arbitrary operations on the ciphertext, making the encryption algorithm very flexible, fully homomorphic encryption supports any given function operation, and can be implemented by a computer as long as this function can be described by an algorithm. Because fully homomorphic encryption can operate on ciphertext without decryption, the cloud server can calculate the user's ciphertext without knowing the user's private key, and the decryption of the calculation result is equivalent to the result of the same calculation on the plaintext. This not only implements the data calculation function, but also guarantees the user data security. This special property makes fully homomorphic encryption widely applicable, such as secure outsourced computing, ciphertext search, and ciphertext machine learning classification.

In 2012, Brakerski et al. proposed a layered fully homomorphic encryption scheme that does not require bootstrap operations, also known as the BGV scheme. The BGV scheme uses key exchange technology to reduce the size of the cipher text, and reduces ciphertext noise through the Modulo exchange technology. It has the security against a known attack 2^{λ}. Using single instruction multiple data technology, the BGV scheme supports parallel processing of multi-bit plaintext. Compared with other fully homomorphic schemes, the BGV scheme has higher homomorphic operation efficiency. Based on the BGV scheme, Helevi constructed a fully homomorphic encryption library HElib in 2013 using Gentry's optimization technology. The key exchange technology and Modulo exchange technology used in the BGV scheme are described as follows:

Key Exchange Technology

Giving keys s₁, s₂ a modulus q, a matrix A and B=τₛ_{₁}_{→s}_{₂}, wherein A·s₂=2c₂∈R_{q}^{N}, R_{q}=R/ [symbol] q [symbol] =Z_{q}[x]/ [symbol] xⁿ+1 [symbol] is an integer polynomial ring of modulo xⁿ+1 and q, N is the number of dimensions, n is an integer power of 2, xⁿ+1 is irreducible in the rational number field, and R=Z[x]/ [symbol] xⁿ+1 [symbol] is an integer polynomial ring of modulo xⁿ+1, the elements in R_{q} are represented by polynomials of degree below n, whose coefficients are selected from {(−q+1)/2, . . . , 1, 0, 1, . . . , (q−1)/2}. The matrices A, B are generated as follows:

SwitchkeyGen(s₁∈R_{q}ⁿ^{₁}, s₂∈R_{q}ⁿ^{₂}):

running a fully homomorphic public key generation algorithm to generate A, wherein N=n₁·┌log q┐, n¹ is the dimension of s¹, and ┌ ┐ means rounding up.

setting B as A+Powersof 2(s₁), that is, adding Powersof 2(s₁)∈R_{q}^{N} to the first column of A, and outputting a transformation matrix τₛ_{₁}_{→s}_{₂}=B, wherein Powersof 2(s₁)=(s₁, 2·s₁, . . . , 2^{└log q┘}·s₁), and └ ┘ means rounding down.

Switch Key(τₛ_{₁}_{→s}_{₂}, c₁): outputting a new ciphertext c₂=BitDecomp(c₁)·B∈R_{q}ⁿ^{₂} with a dimension of n₂, wherein BitDecomp(c₁)=(u₀, u₁, . . . , u_{└log q┘}), u₀, u₁, . . . , u_{└log q┘} represents binary decomposition of c₁ from the lowest bit to the highest bit, and satisfies

$${c}_{1} = {\sum }_{j = 0}^{\vert log q \vert} {2}^{j} \cdot {u}_{j} .$$

Modulo Exchange Technology

Assuming that p and q are two odd modules, and c is ciphertext, new ciphertext c′ is approximately equal to (p/q)·c, and satisfies c′=c mod 2. If |[ [symbol] c,s [symbol] ]_{q}|<q/2−(q/p)·l₁(s) for any key s, then

|[ [symbol] c′,s [symbol] ]ₚ|=|[ [symbol] c,s [symbol] ]_{q}|mod 2,|[ [symbol] c′,s [symbol] ]ₚ|<(p/q)·|[ [symbol] c′,s [symbol] ]_{q}|+l₁(s)

wherein l₁(s) represents a l₁ norm of s. c associated with the original modulo q is converted into c′ associated with the modulo p by the modulo exchange technology.

In the multiplication homomorphism of HElib, the decryption noise of the multiplicative ciphertext is first reduced by the modulo exchange technology, and then the size of the multiplicative ciphertext is reduced by the key exchange technology. It can be seen that the modulo exchange technology is implemented on the multiplication ciphertext of the three ring elements, resulting in low efficiency of multiplication homomorphism. In addition, in Helib's algorithm, each multiplication homomorphism requires the key exchange technology and the modulo exchange technology, which also makes multiplication homomorphism inefficient.

### SUMMARY

The main purpose of the embodiments of the present application is to provide a fully homomorphic encryption method, a device, and a computer-readable storage medium, so as to improve the efficiency of multiplication homomorphism calculation in the fully homomorphic encryption method.

To achieve the foregoing objective, a first aspect of an embodiment of the present application provides a fully homomorphic encryption method, where the method includes:

Step S1: generating a prime modulus qⱼ=qⱼ (λ, L), according to an input security parameter λ and a number of encryption layers L, wherein qⱼ mod n≡1, n is an integer power of 2, j=0, 1, . . . , L−1, and q₀<q₁< . . . <q_{L-1};

Step S2: generating a private key sk and a public key pk according to the prime modulus qⱼ;

Step S3: encrypting plaintext m according to the public key pk; and

Step S4: performing a homomorphic operation on two ciphertexts associated with the same private key, the homomorphic operation includes a homomorphic addition operation FHE.Add (c′, c″) and a homomorphic multiplication operation FHE.Mul(c′, c″), wherein the process of the homomorphic multiplication operation FHE.Mul(c′, c″) is as follows:

calculating a result ciphertext cₘᵤₗ=(c_{mul,0}, c_{mul,1}, c_{mul,2}) according to the following processes, for two ciphertexts c′=(c′₀, c′₁) and c″=(c″₀,c″₁) associated with the same given private key:

c_{mul,0}=[c′₀·c″₀]_{q}_{ⱼ},c_{mul,1}=[c′₀·c″₁+c′₁·c″₀]_{q}_{ⱼ},c_{mul,2}=[c′₁·c″₁]_{q}_{ⱼ}

outputting cₘᵤₗ directly, if cₘᵤₗ undergoes addition homomorphism in a next operation or no operation;

if cₘᵤₗ undergoes multiplication homomorphism in a next operation, reducing the size of the ciphertext of cₘᵤₗ from three ring elements to two ring elements by using the aforementioned key exchange technology, to obtain a new ciphertext c*ₘᵤₗ=(c*_{mul,0},c*_{mul,1}),

wherein c*_{mul,1}=[p·c_{mul,1}+c_{mul,2}·w_{L-1,1}]_{p·q}_{ⱼ}, and j∈[0, L−1].

According to the fully homomorphic encryption method provided by the first aspect of the embodiments of the present application, in step S4, the process of the homomorphic addition operation FHE.Add(c′,c″) is as follows:

for two given ciphertexts c′=(c′₀, c′₁, . . . , c′ᵣ) and c″=(c″₀, c″₁, . . . , c″ₖ) associated with the same private key, wherein r,k∈{1, 2}, and r≤k,

if r=1 and k=1, the homomorphic addition ciphertext is c_{add}=([c′₀+c″₀]_{q}_{ⱼ}, [c′₁+c″₁]_{q}_{ⱼ})

if r=1 and k=2, the homomorphic addition ciphertext is c_{add}=([c′₀+c″₀]_{q}_{ⱼ}, [c′₁+c″₁]_{q}_{ⱼ}, c″₂)

if r=2 and k=2, the homomorphic addition ciphertext is c_{add}=([c′₀+c″₀]_{q}_{ⱼ}, [c′₁+c″₁]_{q}_{ⱼ}, [c′₂+c″₂]_{q}_{ⱼ}),

wherein j∈[0, L−1].

According to the fully homomorphic encryption method provided by the first aspect of the embodiments of the present application, in step S2, the specific process of generating a private key sk and a public key pk according to the prime modulus q, is as follows:

using χ⊂R_{q}_{ⱼ} to represent error distribution, and R_{q}_{ⱼ} to represent an integer polynomial ring of modulo xⁿ+1 and qⱼ, and assuming params=(q_{j=0, 1, . . . , L-1}, χ) and performing the following operation in the key generation function FHE.KeyGen(params):

entering the parameter params, to randomly and uniformly generate s∈R₂, wherein R₂ is the integer polynomial ring of modulo xⁿ+1 and 2 to obtain b=[−(a·s+t·e)]_{q}_{_{L-1}}, wherein a∈R_{q}_{_{L-1}}, error e∈χ, t is a plaintext space modulus, [ ]_{q}_{_{L-1}} represents a modulo q_{L-1} operation; and given an integer p and using an exchange matrix w_{L-1}=(b_{L-1}, a_{L-1}), wherein b_{L-1}=[−a_{L-1}·s+t·e_{L-1}−p·s²]_{p·q}_{_{L-1}}, a_{L-1}∈R_{q}_{_{L-1}} and e_{L-1}∈χ, to obtain the private key sk=s and the public key pk=(b, a, w_{L-1}).

According to the fully homomorphic encryption method provided by the first aspect of the embodiments of the present application, step S3 specifically includes:

given m∈Rₜ in an encryption function FHE.Enc(pk, m), wherein Rₜ is an integer polynomial ring of modulo x″+1 and 2, randomly selecting u and eᵢ from χ, where i=0, 1, and generating ciphertext c according to the following formula: c=([m+b·u+t·e₁]_{q}_{_{L-1}}, [a·u+t·e₂]_{q}_{_{L-1}}).

According to the fully homomorphic encryption method provided by the first aspect of the embodiments of the present application, the method further includes a decryption operation FHE.Dec(c,sk), wherein the ciphertext is defined as c=(c₀, c₁, . . . , cₖ), and

if k=1, then m=[[c₀+c₁·s]_{q}_{ⱼ}]ₜ,

if k=2, then m=[[c₀+c₁·s+c₂·s²]_{q}_{ⱼ}]ₜ.

The fully homomorphic encryption method provided by the first aspect of the embodiments of the present application is characterized in that Step S1 is performed by a prime modulus generating function FHE.Setup(1^{l},L).

A second aspect of the embodiments of the present application provides a fully homomorphic encryption device, which includes at least one processor, memory, and an interface which are connected through a bus;

the memory stores computer execution instructions; and

the at least one processor executes computer execution instructions stored in the memory, to cause the fully homomorphic encryption device to perform the steps of the fully homomorphic encryption method provided by the first aspect of the embodiments of the present application.

A third aspect of the embodiments of the present application provides a computer-readable storage medium, wherein the computer-readable storage medium stores a computer program, and the computer program, when executed by a processor, performs the steps of the fully homomorphic encryption method provided by the first aspect of the embodiments of the present application.

Compared with the prior art, the fully homomorphic encryption method of the present application is mainly embodied in the following two aspects.

Firstly, in order to improve the efficiency of multiplication homomorphism, the improved multiplication homomorphism algorithm FHE.Mul of the present application first reduces the multiplication cipher text size from three ring elements to two ring elements by using key exchange technology, and then uses modulo exchange technology to reduce the modulus and decryption noise of the multiplication ciphertext.

Secondly, in order to improve the efficiency of homomorphic operations, the present application improves the addition homomorphic algorithm FHE.Add to support the operation of three ring elements, so that the key exchange technology and the modulo exchange technology are called as seldom as possible during multiplication homomorphism.

### BRIEF DESCRIPTION OF DRAWINGS

In order to make a clearer description of technical solutions in specific implementations of the present application or prior arts, drawings involved in description for the specific implementations or the prior arts will be briefly introduced, and apparently, the drawings described below illustrate some implementations of the present application, for one with ordinary skill in the art, other drawings can also be obtained in accordance with these drawings without delivering creative efforts.

FIG. 1 is a flowchart of a fully homomorphic encryption method provided by an embodiment of the present application;

FIG. 2 is a structural block diagram of a fully homomorphic encryption device provided by an embodiment of the present application.

### DETAILED DESCRIPTION

In order to make the purpose, technical solutions and advantages in embodiments of the present application clearer, the technical solutions in the embodiments of the present application will be described as follows clearly and completely referring to figures accompanying the embodiments of the present application, and surely, the described embodiments are just part rather than all embodiments of the present application. Based on the embodiments of the present application, all the other embodiments acquired by those skilled in the art without delivering creative efforts shall fall into the protection scope of the present application.

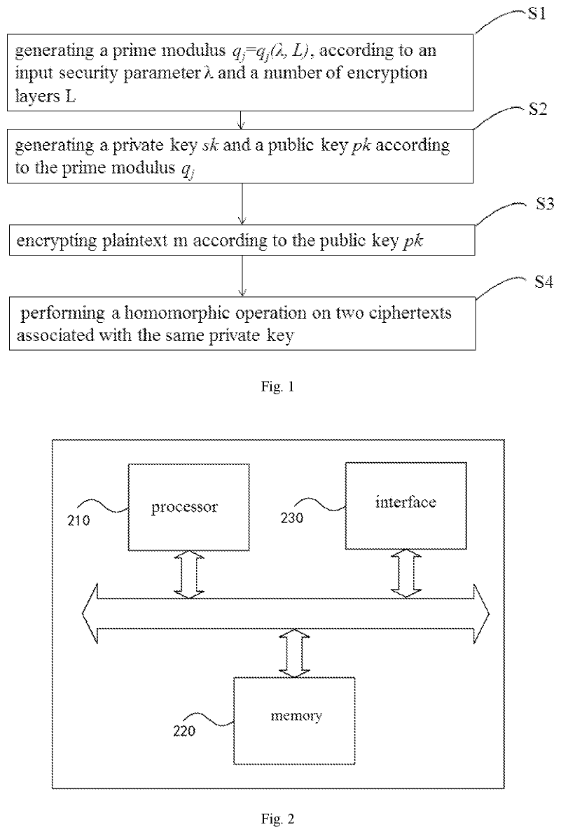

As shown in FIG. 1, the fully homomorphic encryption method provided by the embodiment of the present application mainly includes steps S1 to S4, which will be described in detail below.

Step S1: generating a prime modulus qⱼ=qⱼ (λ, L), according to an input security parameter λ and a number of encryption layers L, wherein qⱼ mod n≡1, n is an integer power of 2, j=0, 1, . . . , L−1, and q₀<q₁< . . . <q_{L-1}.

It should be noted that step S1 is implemented by a prime modulus generating function FHE.Setup(1^{l}, L)

Step S2: generating a private key sk and a public key pk according to the prime modulus qⱼ.

Specifically, the specific process of generating the private key sk and the public key pk according to the prime modulus qⱼ is as follows:

using χ⊂R_{q}_{ⱼ} to represent error distribution, and R_{q}_{ⱼ} to represent an integer polynomial ring of modulo xⁿ+1 and qⱼ, and assuming params=(q_{j=0, 1, . . . , L-1}, χ), and performing the following operation in the key generation function FHE.KeyGen(params):

entering the parameter params, to randomly and uniformly generate s∈R₂, wherein R₂ is the integer polynomial ring of modulo xⁿ+1 and 2 to obtain b=[−(a·s+t·e)]_{q}_{_{L-1}}, wherein a∈R_{q}_{_{L-1}}, error e∈χ, t is a plaintext space modulus, [ ]_{q}_{_{L-1}} represents a modulo q_{L-1} operation; and given an integer p and using an exchange matrix w_{L-1}=(b_{L-1}, a_{L-1}), wherein b_{L-1}=[−a_{L-1}·s+t·e_{L-1}−p·s²]_{p·q}_{_{L-1}}, a_{L-1}∈R_{q}_{_{L-1}} and e_{L-1}∈χ, to obtain the private key sk=s and the public key pk=(b, a, w_{L-1}).

Step S3: encrypting plaintext m according to the public key pk; and

Step S3 specifically includes:

given m∈Rₜ in an encryption function FHE.Enc(pk, m), wherein Rₜ is an integer polynomial ring of modulo x″+1 and 2, randomly selecting u and eᵢ from χ, where i=0, 1, and generating ciphertext c according to the following formula: c=([m+b·u+t·e₁]_{q}_{_{L-1}}, [a·u+t·e₂]_{q}_{_{L-1}}).

Step S4: performing a homomorphic operation on two ciphertexts associated with the same private key, the homomorphic operation includes a homomorphic addition operation FHE.Add(c′, c″) and a homomorphic multiplication operation FHE.Mul(c′,c″),

wherein the process of the homomorphic multiplication operation FHE.Mul(c′, c″) is as follows:

calculating a result ciphertext cₘᵤₗ=(c_{mul,0}, c_{mul,1}, c_{mul,2}) according to the following processes, for two ciphertexts c′=(c′₀, c′₁) and c″=(c″₀,c″₁) associated with the same given private key:

c_{mul,0}=[c′₀·c″₀]_{q}_{ⱼ},c_{mul,1}=[c′₀·c″₁+c′₁·c″₀]_{q}_{ⱼ},c_{mul,2}=[c′₁·c″₁]_{q}_{ⱼ}

outputting cₘᵤₗ directly, if cₘᵤₗ undergoes addition homomorphism in a next operation or no operation;

if cₘᵤₗ undergoes multiplication homomorphism in a next operation, reducing the size of the ciphertext of cₘᵤₗ from three ring elements to two ring elements by using the aforementioned key exchange technology, to obtain a new ciphertext c*ₘᵤₗ=(c*_{mul,0},c*_{mul,1}),

wherein c*_{mul,1}=[p·c_{mul,1}+c_{mul,2}·w_{L-1,1}]_{p·q}_{ⱼ}, and j∈[0, L−1].

c*ₘᵤₗ is transformed into c_{fresh} by using the aforementioned modular switching technology, and the modulus is reduced from p·qⱼ to qⱼ, and the decryption noise is also reduced.

The process of the homomorphic addition operation FHE.Add(c′, c″) is as follows:

for two given ciphertexts c′=(c′₀,c′₁, . . . ,c′ᵣ) and c″=(c″₀,c″₁, . . . ,c″ₖ) associated with the same private key, wherein r,k∈{1,2}, and r≤k,

if r=1 and k=1, the homomorphic addition ciphertext is c_{add}=([c′₀+c″₀]_{q}_{ⱼ}, [c′₁+c″₁]_{q}_{ⱼ})

if r=1 and k=2, the homomorphic addition ciphertext is c_{add}=([c′₀+c″₀]_{q}_{ⱼ}, [c′₁+c″₁]_{q}_{ⱼ}, c″₂)

if r=2 and k=2, the homomorphic addition ciphertext is c_{add}=([c′₀+c″₀]_{q}_{ⱼ}, [c′₁+c″₁]_{q}_{ⱼ}, [c′₂+c″₂]_{q}_{ⱼ}),

wherein j∈[0, L−1].

After the encryption is completed, the encrypted cipher text c=(c₀, c₁, . . . , cₖ) is decrypted by FHE.Dec(c,sk), and the original plain text m therein can be restored, as follows:

If k=1, then m=[[c₀+c₁·s]_{q}_{ⱼ}]ₜ

If k=2, then m=[[c₀+c₁·s+c₂·s²]_{q}_{ⱼ}]ₜ

It should be noted that the security of the above-mentioned fully homomorphic encryption method depends on an error learning hypothesis on the ring (RLWE) problem. The difficulty of the RLWE problem is determined by the safety parameter λ, parameter m, and prime modulus q. In order to ensure λ of the proposed scheme, phi(m)>log₂(q)·(λ+110)/7.2 is required, where phi(m) represents the dimension of a cyclotomic polynomial Φm (x). If λ is a constant, q will increase as m increases. For example, let λ=80, if phi(m)=1176, then log₂(q)=44, that is, m=1247, q=2⁴⁴; if phi(m)=2880, then log₂(q)=109, that is m=3133, q=2¹⁰⁹.

The advantages of the above-mentioned fully homomorphic encryption method are mainly reflected in the following two aspects.

Firstly, in order to improve the efficiency of multiplication homomorphism, the improved multiplication homomorphism algorithm FHE.Mul of the present application first reduces the multiplication cipher text size from three ring elements to two ring elements by using key exchange technology, and then uses modulo exchange technology to reduce the modulus and decryption noise of the multiplication ciphertext.

Secondly, in order to improve the efficiency of homomorphic operations, the present application improves the addition homomorphic algorithm FHE.Add to support the operation of three ring elements, so that the key exchange technology and the modulo exchange technology are called as little as possible during multiplication homomorphism.

As shown in FIG. 2, an embodiment of the present application further provides a fully homomorphic encryption device, which includes at least a processor 210, a memory 220, and an interface 230 which are connected through a bus.

The memory 220 stores computer-executable instructions;

The at least one processor 210 executes computer execution instructions stored in the memory 220, so that the fully homomorphic encryption device implements the steps of the above-mentioned fully homomorphic encryption method.

In the embodiments provided by the present application, it should be understood that the disclosed device and method may be implemented in other ways. For example, the device embodiments described above are only schematic. For example, the division of the modules is only a logical function division, and can be realized in other manners in actual implementation. For example, multiple modules or components may be combined or integrated into another system, or some features can be ignored or not implemented. In addition, the displayed or discussed mutual coupling or direct coupling or communication connection may be indirect coupling or communication connection through some interfaces, devices or modules, which may be electrical, mechanical or other forms.

The modules described as separate components may or may not be physically separated, and the components displayed as modules may or may not be physical modules, may be located in one place, or may be distributed on multiple network modules. Some or all of the modules may be selected according to actual needs to achieve the objective of the solution of this embodiment.

In addition, each functional module in each embodiment of the present application may be integrated into one processing module, or each module may exist separately physically, or two or more modules may be integrated into one module. The above integrated modules can be implemented in the form of hardware or software functional modules.

When the integrated module is implemented in the form of a software functional module and sold or used as an independent product, it can be stored in a computer-readable storage medium. Based on this understanding, the essential technical solution of the present application, or part of the technical solution that contributes to the existing technology, or all or part of the technical solution can be embodied in the form of a software product, which is stored in a storage medium which comprises a number of instructions for causing a computer device (which may be a personal computer, a server, or a network device, etc.) to perform all or part of the steps of the method described in each embodiment of the present application. The foregoing storage media includes: U disk, mobile hard disk, read-only memory (ROM, Read-Only Memory), random access memory (RAM, Random Access Memory), magnetic disks or optical disks and other media that can store program codes.

It should be noted that, the foregoing method embodiments, for simplicity of description, are all described as a series of action combinations, but those skilled in the art should know that the present application is not limited by the described sequence of actions. Because according to the present application, certain steps may be performed in another order or simultaneously. Secondly, those skilled in the art should also know that the embodiments described in the specification are all preferred embodiments, and the actions and modules involved are not necessarily required by the present application.

In the above embodiments, the description of each embodiment has its own emphasis. For a part that is not described in detail in an embodiment, reference may be made to related descriptions of other embodiments.

The foregoing is a description of the fully homomorphic encryption method, device, and computer-readable storage medium provided by the present application. For those skilled in the art, according to the ideas of the embodiments of the present application, the specific implementation and application scope will be changed. In summary, the content of this specification should not be construed as a limitation on the present application.

1. A fully homomorphic encryption method, comprising:
Step S1: generating a prime modulus qⱼ=qⱼ (λ, L), according to an input security parameter λ and a number of encryption layers L, wherein qⱼ mod n≡1, n is an integer power of 2, j=0, 1, . . . , L−1, and q₀<q₁< . . . <q_{L-1};
Step S2: generating a private key sk and a public key pk according to the prime modulus qⱼ;
Step S3: encrypting plaintext m according to the public key pk; and
Step S4: performing a homomorphic operation on two ciphertexts associated with the same private key, the homomorphic operation includes a homomorphic addition operation FHE.Add (c′, c″) and a homomorphic multiplication operation FHE.Mul(c′, c″), wherein the process of the homomorphic multiplication operation FHE.Mul(c′, c″) is as follows:
calculating a result ciphertext cₘᵤₗ=(c_{mul,0}, c_{mul,1}, c_{mul,2}) according to the following processes, for two ciphertexts c′=(c′₀, c′₁) and c″=(c″₀,c″₁) associated with the same given private key:
c_{mul,0}=[c′₀·c″₀]_{q}_{ⱼ}, c_{mul,1}=[c′₀·c″₁+c′₁·c″₀]_{q}_{ⱼ}, c_{mul,2}=[c′₁·c″₁]_{q}_{ⱼ}
outputting cₘᵤₗ directly, if cₘᵤₗ undergoes addition homomorphism in a next operation or no operation;
if cₘᵤₗ undergoes multiplication homomorphism in a next operation, reducing the size of the ciphertext of cₘᵤₗ from three ring elements to two ring elements by using the aforementioned key exchange technology, to obtain a new ciphertext c*ₘᵤₗ=(c*_{mul,0},c*_{mul,1}),
wherein c*_{mul,1}=[p·c_{mul,1}+c_{mul,2}·w_{L-1,1}]_{p·q}_{ⱼ}, and j∈[0, L−1].

2. The fully homomorphic encryption method of claim 1, wherein, in step S4, the process of the homomorphic addition operation FHE.Add(c′,c″) is as follows:
for two given ciphertexts c′=(c′₀, c′₁, . . . , c′ᵣ) and c″=(c″₀, c″₁, . . . , c″ₖ) associated with the same private key, wherein r,k∈{1, 2}, and r≤k,
if r=1 and k=1, the homomorphic addition ciphertext is c_{add}=([c′₀+c″₀]_{q}_{ⱼ}, [c′₁+c″₁]_{q}_{ⱼ})
if r=1 and k=2, the homomorphic addition ciphertext is c_{add}=([c′₀+c″₀]_{q}_{ⱼ}, [c′₁+c″₁]_{q}_{ⱼ}, c″₂)
if r=2 and k=2, the homomorphic addition ciphertext is c_{add}=([c′₀+c″₀]_{q}_{ⱼ}, [c′₁+c″₁]_{q}_{ⱼ}, [c′₂+c″₂]_{q}_{ⱼ}),
wherein j∈[0, L−1].

3. The fully homomorphic encryption method of claim 1, wherein, in step S2, the specific process of generating a private key sk and a public key pk according to the prime modulus qⱼ is as follows:
using χ⊂R_{q}_{ⱼ} to represent error distribution, and R_{q}_{ⱼ} to represent an integer polynomial ring of modulo xⁿ+1 and qⱼ, and assuming params=(q_{j=0, 1, . . . , L-1}, χ), and performing the following operation in the key generation function FHE.KeyGen(params):
entering the parameter params, to randomly and uniformly generate s∈R₂, wherein R₂ is the integer polynomial ring of modulo xⁿ+1 and 2 to obtain b=[−(a·s+t·e)]_{q}_{_{L-1}}, wherein a∈R_{q}_{_{L-1}}, error e∈χ, t is a plaintext space modulus, [ ]_{q}_{_{L-1}} represents a modulo q_{L-1} operation; and given an integer p and using an exchange matrix w_{L-1}=(b_{L-1}, a_{L-1}), wherein b_{L-1}=[−a_{L-1}·s+t·e_{L-1}−p·s²]_{p·q}_{_{L-1}}, a_{L-1}∈R_{q}_{_{L-1}} and e_{L-1}∈χ, to obtain the private key sk=s and the public key pk=(b, a, w_{L-1}).

4. The fully homomorphic encryption method of claim 3, wherein, Step S3 specifically comprises:
given m∈Rₜ in an encryption function FHE.Enc(pk, m), wherein Rₜ is an integer polynomial ring of modulo x″+1 and 2, randomly selecting u and eᵢ from χ, where i=0, 1, and generating ciphertext c according to the following formula:
c=([m+b·u+t·e₁]_{q}_{_{L-1}},[a·u+t·e₂]_{q}_{_{L-1}}).

5. The fully homomorphic encryption method of claim 1, further comprising a decryption operation FHE.Dec(c, sk), wherein the ciphertext defined as c=(c₀, c₁, . . . , cₖ), and if k=1, then m=[[c₀+c₁·s]_{q}_{ⱼ}]ₜ, if k=2, then m=[[c₀+c₁·s+c₂·s²]_{q}_{ⱼ}]ₜ.

6. The fully homomorphic encryption method of claim 1, wherein Step S1 is performed by a prime modulus generating function FHE.Setup(1^{l}, L).

7. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 1.

8. A computer-readable storage medium storing a computer program, wherein the computer program, when executed by a processor, performs the steps of the method of claim 1.

9. The fully homomorphic encryption method of claim 2, further comprising a decryption operation FHE.Dec(c, sk), wherein the ciphertext is defined as c=(c₀, c₁, . . . , cₖ), and if k=1,then m=[[c₀+c₁·s]_{q}_{ⱼ}]ₜ, if k=2, then m=[[c₀+c₁·s+c₂·s²]_{q}_{ⱼ}]ₜ.

10. The fully homomorphic encryption method of claim 3, further comprising a decryption operation FHE.Dec(c, sk), wherein the ciphertext is defined as c=(c₀, c₁, . . . , cₖ), and if k=1,then m=[[c₀+c₁·s]_{q}_{ⱼ}]ₜ, if k=2, then m=[[c₀+c₁·s+c₂·s²]_{q}_{ⱼ}]ₜ.

11. The fully homomorphic encryption method of claim 4, further comprising a decryption operation FHE.Dec(c, sk), wherein the ciphertext is defined as c=(c₀, c₁, . . . , cₖ), and if k=1, then m=[[c₀+c₁·s]_{q}_{ⱼ}]ₜ, if k=2, then m=[[c₀+c₁·s+c₂·s²]_{q}_{ⱼ}]ₜ.

12. The fully homomorphic encryption method of claim 2, wherein Step S1 is performed by a prime modulus generating function FHE.Setup(1^{l}, L).

13. The fully homomorphic encryption method of claim 3, wherein Step S1 is performed by a prime modulus generating function FHE.Setup(1^{l}, L).

14. The fully homomorphic encryption method of claim 4, wherein Step S1 is performed by a prime modulus generating function FHE.Setup(1^{l}, L).

15. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 2.

16. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 3.

17. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 4.

18. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 5.

19. A fully homomorphic encryption device, comprising at least one processor, memory, and an interface which are connected through a bus;
the memory stores computer execution instructions;
the at least one processor executes computer execution instructions stored in the memory, to cause the fully homomorphic encryption device to perform the steps of the method of claim 6.

20. A computer-readable storage medium storing a computer program, wherein the computer program, when executed by a processor, performs the steps of the method of claim 2.
